(19) United States
(12) Patent Application Publication
(10) Pub. No.: US 2004/0138969 A1
(43) Pub. Date: Jul. 15, 2004

(54) Method and system for donation decision support

(76) Inventors: Thomas L. Goldsmith, Coconut Grove, FL (US); Candace L. Quinn, Weston, FL (US)

Correspondence Address: SQUIRE, SANDERS & DEMPSEY L.L.P., Two Renaissance Square, Suite 2700, 40 North Central Avenue, Phoenix, AZ, 85004-4498, US

(21) Appl. No.: 10/686,873

(22) Filed: Oct. 16, 2003

Related U.S. Application Data
(60) Provisional application No. 60/419,291, filed on Oct. 16, 2002.

(51) Int. Cl. G06F 17/60

(52) U.S. Cl. 705/30

(57) ABSTRACT

A computer automated method for decision support related to dispositioning resources raises user awareness of an advantage of special treatment. A user of a system that performs such a method may be presented with a comparison of projected outcomes which may be affected by the special treatment. For example, the comparison may lead to a decision to donate surplus inventory to obtain a tax deduction and enjoy higher earnings than realizable with other dispositions of the surplus inventory. Systems of the present invention include enterprise management systems coupled to a global network. The network includes a service provider and coordinator process that provides information to the enterprise management system for decision support. A user platform of the enterprise management system may include a decision support process having alerting, estimating, and dispositioning processes related to dispositioning over-valued or under-utilized goods from inventory.

### CROSS-REFERENCE TO RELATED APPLICATIONS

This application claims benefit under 35 U.S.C. 120 to U.S. Provisional Patent Application No. 60/419,291 filed Oct. 16, 2002 by Thomas Goldsmith, et. al., incorporated herein by reference.

### FIELD OF THE INVENTION

Embodiments of the present invention relate to resource management.

### BACKGROUND OF THE INVENTION

The value of items in inventory generally decreases over time. Though the value of perishable goods decreases due to spoilage, the value of nonperishable goods also decreases. For a finished goods inventory, a decreasing value may be attributed to decreasing demand for the item or an expected decrease in demand based on a product life cycle model. For a manufacturing inventory, a decreasing value may be attributed to increased availability of lower cost exact replacement items, alternate goods for the same purpose, or changes in technology that obviate the need for the item.

Conventional inventory management systems indicate to a user the age of inventory items to facilitate disposition of aged items. Retaining aged items adversely affects costs associated with the inventory in several ways including real costs and lost opportunity costs, for example, taking up space to which a continuing cost per square foot per month applies, and obstructing the acquisition and storage of newer inventory items. A user of a conventional inventory management system may request reports from the inventory management system that identify items older than a given age. The user may then arrange disposition of the aged items without further assistance from the inventory management system.

Disposition of aged goods typically involves finding a market, seeking a buyer, estimating the value of the aged goods, making an offer at a reasonable price, closing a sale, removing the aged goods from inventory, and possibly transporting the aged goods to the buyer. The vendors involved in obtaining the goods in the first place constitute what is conventionally called a supply chain. The original supply chain is generally not interested in participating in disposition of aged goods and generally has little experience in marketing aged goods. Consequently, the owner of aged goods generally faces the disposition with a substantial lack of information.

Conventional decision support systems provide executives and managers with information gathered, analyzed, and presented in a manner that provides facts and intermediate conclusions as a basis for a business decision. Unfortunately, conventional systems do not assist the owner of aged goods in deciding which of several alternate ways of disposition is most suitable. Conventional ways for disposition include selling to a liquidator, selling at auction, discarding, and donating to charity.

Supply chain management continues to reduce costs in acquiring goods, yet the effect of aged goods on inventory costs remains high. Without methods and systems for donation decision support, these costs will continue to be recovered in higher costs to consumers of related goods and services.

### SUMMARY OF THE INVENTION

A computer automated method for decision support related to dispositioning resources raises user awareness of an advantage of special treatment. A user of a system that performs such a method may be presented with a comparison of projected outcomes which may be affected by the special treatment. For example, the comparison may lead to a decision to donate surplus inventory to obtain a tax deduction and enjoy higher earnings than realizable with other dispositions of the surplus inventory. Systems of the present invention include enterprise management systems coupled to a global network. The network includes a service provider and coordinator process that provides information to the enterprise management system for decision support. A user platform of the enterprise management system may include a decision support process having alerting, estimating, and dispositioning processes related to dispositioning over-valued or under-utilized goods from inventory.

### BRIEF DESCRIPTION OF THE DRAWING

Embodiments of the present invention will now be further described with reference to the drawing, wherein like designations denote like elements, and:

FIG. 1 is a functional block diagram of a computer system according to various aspects of the present invention; and

FIG. 2 is a data flow diagram of processes performed by the computer system of FIG. 1; and

FIG. 3 is a plan view of a presentation to a user of the computer system of FIG. 1.

### DETAILED DESCRIPTION OF THE PREFERRED EMBODIMENTS

A system, according to various aspects of the present invention, obtains information about over-valued and/or under-utilized resources and presents information to assist in decision making regarding a potential disposition of such resources. One implementation performs the functions of a conventional enterprise resource planning computer program and in addition performs functions to support timely decision making regarding disposition. For instance, decision support may present to the decision maker a comparative analysis of the effect on earnings of alternative dispositions of goods such as by liquidation sale, auction sale, or donation. These alternatives may have different effects on earnings as a result of application of corporate income tax regulations. Decision support as provided by such a system includes projecting tax consequences and providing to the decision maker information on which the decision maker may select a disposition such as by donation on the basis that donation provides greater earnings than provided by sale.

Methods according to various aspects of the present invention are performed by one or more computers for decision support. Decision support may include recognizing over-valued and/or under-utilized resources, obtaining valuations of such resources, determining tax consequences of alternative dispositions, and presenting information as a basis for a decision. Decision support may further include accepting input as to the decision made, and facilitating the selected disposition. Input as to the decision made may include any conventional input from a user that specifies a choice, selection, preference, or priority concerning one or more alternative dispositions. Facilitating disposition may include, for example, advertising resources for sale, placing resources for auction, transferring payment to escrow for decision support services, creating an order to initiate a shipment, and/or notifying a charity of a gift.

Costs associated with a resource and expected profits may be used to estimate a present value of the resource. A resource may be considered over-valued when the present value exceeds an estimated fair market value for the resource if sold or otherwise dispositioned for profit (e.g., goods incorporated into a product). The opportunity to disposition over-valued resources may be time limited. Automated decision support according to various aspects of the present invention provides the decision maker with better capability to take advantage of such time limited opportunities.

A present utilization of a resource may be estimated or monitored in any conventional manner. Present utilization may include a probability of utilization in the near future. For example, if an oven is out of use currently but will be needed to serve an expected future contract, the probability of being awarded the contract may be a factor in estimating present utilization. A resource may be considered under-utilized when the present utilization falls below a user defined threshold.

Resources include goods and/or services. Goods may include finished goods (e.g., clothing, furniture), components, materials, or supplies for manufacturing, repair, operation, or training (e.g., aids for teaching operators). Services may include manual services (e.g., services of basic laborers or skilled technicians). Typically, implementations of methods and systems of the present invention relate to donatable resources for which organizations exist having a market demand for such donatable resources.

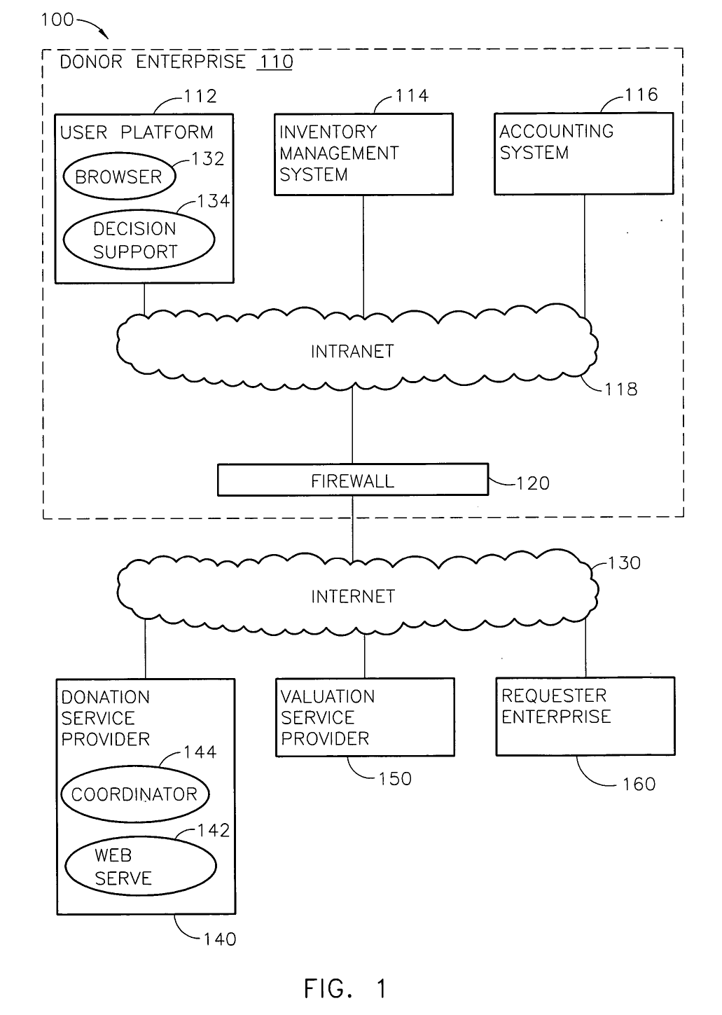

A system that provides decision support as discussed above typically includes several computers coupled by conventional communication networks. For example, system 100 of FIG. 1 includes a donor enterprise 110, donation service provider 140, valuation service provider 150, and requester enterprise 160 each coupled to a conventional network 130 (e.g., a global network, the Internet). Each enterprise and each service provider is implemented using conventional server technologies providing reliable data storage and computation capability for sending conventional messages and responding to conventional messages communicated over network 130. Network 130 provides an information highway among service providers and enterprises shown as well as additional service providers, enterprises, and individual user platforms (not shown).

System 100 in other implementations includes numerous donor enterprises of which donor enterprise 110 is exemplary; and numerous requester enterprises of which requester enterprise 160 is exemplary. The same enterprise may operate from time to time as donor, requester, or both. System 100 in other implementations includes numerous service providers of which providers 140 and 150 are typical.

A donor enterprise includes any enterprise, typically a business entity having numerous resources and numerous employees some of whom may be authorized to make decisions regarding disposition of resources. For example, donor enterprise 110 includes a user platform 112, an inventory management system 114, an accounting system 116, a firewall 120, all coupled to an intranet 118. User platform 112 as shown is typical of any number of user platforms that are in some way related to the business entity and coupled in any conventional manner to intranet 118, including via a geographically remote connection through internet 130. User platform 112 may include an office computer or lap top computer for performing a conventional operating system and a conventional browser 132. In addition, user platform 112 performs a decision support process 134, that provides decision support as discussed above according to various aspects of the present invention.

Inventory management system 114, accounting system 116, firewall 120, and intranet 118 may be implemented using conventional technologies at one or more geographic locations and on one or more computers. For example, an enterprise that is a sole proprietorship may implement donor enterprise 110 on one computer; while an enterprise that is a multinational corporation may implement donor enterprise 110 on dozens of suitably independent reliable nodes of networks 118 and/or 130. For example, inventory management system 114 may be integrated with accounting system 116 as one application performed under one operating system. In another implementation, inventory management system is an inventory collaboration and supply chain management system of the type known as mySAP SCM marketed by SAP AG (Germany).

A service provider includes functions of a conventional application service provider including web server functions. In addition, each service provider includes one or more processes that provide the functions particular to the type of service it provides. For example, donation service provider 140, according to various aspects of the present invention, includes web serve process 142 and coordinator process 144. Web serve process 142 includes conventional session management, database management, and download functions (e.g., to download process 134 to a new donor enterprise). Coordinator process 144 provides decision support as discussed above in sessions with donor enterprise 110 with reference to a database (not shown) of donation service provider 140.

A valuation service provider provides conventional information exchange with donation service provider(s) and/or enterprises. Information exchange suitably includes a receiving a description of a resource for which valuation is desired, receiving a request for valuation, and transmitting a report of valuation according to the request. In one implementation descriptions, requests, and reports are messages conforming to conventional data exchange protocols and structures such as Extended Markup Language (XML) for platform independent communication. For example, valuation service provider 150 communicates with coordinator process 144 via web serve process 142 for receiving and transmitting as discussed above. The reported valuation may be determined in any conventional manner including, for example, as an average of transactions stored in a database of provider 150, on request by provider 150 to other web sites (not shown), or from human users (e.g., certified appraisers) who make inputs to provider 150 in advance of or in response to each request from coordinator 144.

A requester enterprise may be any enterprise as discussed above having at least one user platform. In one implementation, functions of inventory management, accounting, and decision support (e.g., 134) are omitted as these are not generally needed for functions of a requester. In operation, a user of a requester enterprise requests from time to time ownership or use of one or more resources.

Systems and methods according to the present invention enable an enterprise to obtain a special treatment based on information exchange implemented by decision support and coordination as discussed above tailored to the conditions particular to the special treatment. For example special treatment as in the illustrated implementation is based on corporate income tax law. Any other conditional special treatment may be the basis for other implementations.

Ownership or use as requested by enterprise 160 is of a type recognized for special treatment to a donor enterprise. Special treatment in the illustrated example is treatment under corporate income tax law includes treatment according to the type of enterprise, resource, ownership, and/or use such that donor enterprise 110, according to the decision made with decision support as discussed herein, may receive a benefit, avoid a penalty, conform to law, or appreciate an incentive.

As an example of operation of system 100 consider requester enterprise 160 being a charity, resources being surplus retail goods in inventory of donor enterprise 110, and the special treatment includes enterprise 110 being awarded a deduction under corporate income tax law for a suitable charitable donation by donor enterprise 110 to requester enterprise 160.

In a first scenario, donation service provider 140 discovers or is otherwise in contact with valuation service provider(s) 150 to permit efficient valuations of various surplus retail goods. Donation service provider is available on internet 130 to users of enterprises 110 and 160. Users of various requester enterprises 160 post independent requests for gift each specifying a quantity of retail goods such as computers, desks, clothing, food, and building materials. Users of various donor enterprises contact donation service provider 140 for decision support with regard to known quantities of over-valued or under-utilized donatable goods. For instance, decision support process 134 contacts coordinator process 144 with regard to 600 laptop computers. Coordinator process 144 obtains from valuation service provider 150 a valuation of the 600 laptop computers. Coordinator process 144 may also contact liquidation service providers and auction service providers (not shown) for respective valuations. The valuation may include expected value if sold by liquidation, expected value if auctioned, fair market value, and value for purposes of suitable charitable donation. Valuations are reported to decision support process 134. In addition, coordinator process 144 may associate requester enterprise 160, donor enterprise 110, the resource, and the request for gift. Decision support process 134 presents to a human decision maker a comparison of projected after tax earnings that result from three alternative dispositions of the 600 computers: sale to a liquidator, sale by auction, and gift to the organization that a user of requester enterprise 160 represents. The human decision maker at donor enterprise 110 may be unaware of the identity of valuation service provider 150. In an alternate implementation, decision support process 134 reports an identity of valuation service provider 150 or an identity of the source of data used by valuation service provider 150 to substantiate the valuation. If a decision is made, decision support process 134 may provide notice to coordinator process 144. In reply coordinator process 144 may provide contact information to facilitate completing of a business transaction for the decided disposition. Contact information may be provided in any conventional manner regarding donor enterprise 110 and requester enterprise 160. Alternatively, anonymity of the parties to the disposition may be preserved by providing contract information to a shipper/escrow agent acting between the parties. Contact information for each enterprise or an enterprise of the shipper/escrow agent may include a uniform resource locator (URL) link, an exchange of email addresses, parties names, phone numbers, physical addresses, and/or shipping authorizations.

The scenario discussed above may be preceded by several independent sessions that enable coordinator process 144 to recover expenses and possibly to operate for profit. In addition to the services discussed above, coordinator 144 may preserve the anonymity of the donor enterprise and the requester enterprise. A fee for performing as a donation service provider (including preserving anonymity) may be collected from each donor enterprise. The fee may be based on registration (e.g., an annual fee) and/or based on transactions facilitated or completed with information provided by donation service provider 140. Independent sessions include registration of enterprises and service providers and may include collection of fees (e.g., transaction fee held in escrow until transaction is facilitated). Coordinator process 144 may register each entity by adding records containing identification, contact information, and possibly resource descriptions to a database of donation service provider 140 (not shown). Donor enterprises register with coordinator process 144 and in reply obtain an installation of decision support process 134. Registered donor enterprises may prepay fees that are held in escrow by or for donation service provider 140. Requester enterprises register and in reply may receive a catalog of resource descriptions. Requester enterprises may pay fees for donation services provided by 140. Valuation service providers, and shipper/escrow agent service providers register with coordinator process 144 and in reply may receive a portion of any fees collected or being held in escrow by or for donation service provider 140 for particular requester enterprises, donor enterprises, resources, or transactions.

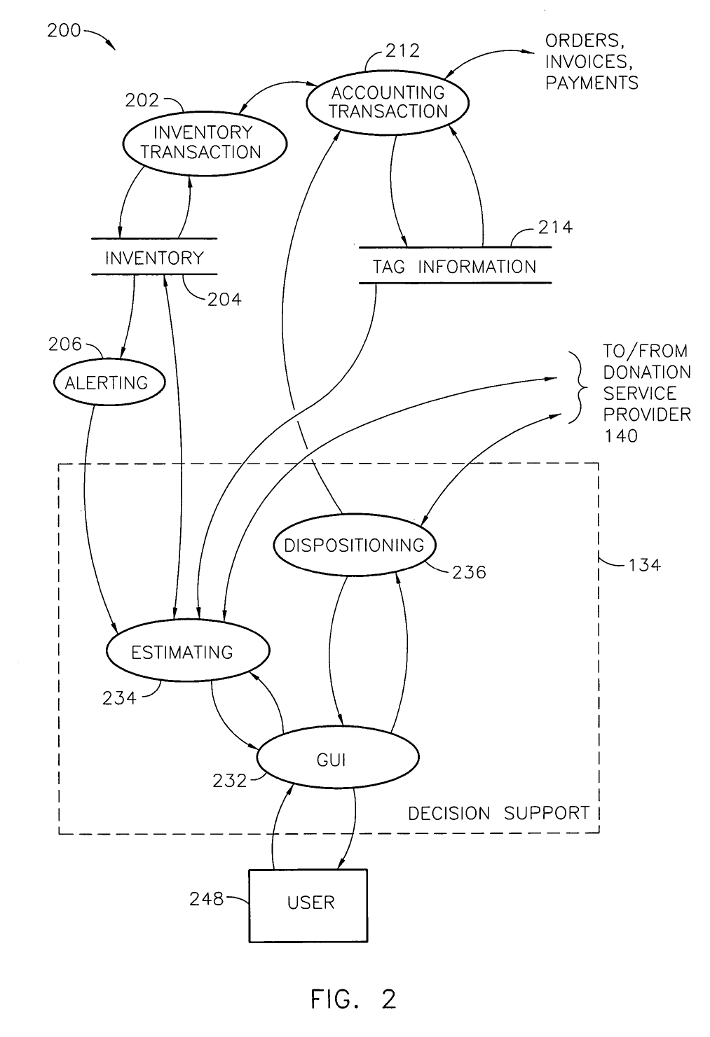

Processes performed by user platform 112 in one implementation according to various aspects of the present invention include process 200 of FIG. 2. Process 200 corresponds to the scenarios discussed above. Process 200 includes inventory transaction process 202, inventory store 203, alerting process 206, accounting transaction process 212, tax information store 214, estimating process 234, dispositioning process 236, and graphical user interface (GUI) process 232. User 248 (e.g., a human decision maker) may cooperate with GUI 232 to receive decision support and indicate a decision made. In other implementations, tax information store may be omitted and another store having information regarding another type of benefit, incentive,

Inventory transaction process 202 and accounting transaction process 212 are conventional processes as discussed above that cooperate to maintain updated information in inventory store 204 and tax information store 214. This cooperation is sufficient for conducting the ordinary business of donor enterprise 110. For example, if donor enterprise 110 is a finished goods wholesaler, purchase orders are provided for goods to add to inventory, sales orders are received for goods to be withdrawn from inventory, invoices are received for goods added to inventory, invoices are sent for goods withdrawn from inventory, and payments are suitably sent and received.

Inventory store 204 includes any conventional inventory database and application software. Processes 202 and 206 may be standard or customized processes of any otherwise conventional inventory management system 114.

Accounting transaction process 212 and tax information store may be standard or customized processes of any otherwise conventional accounting system 116.

Tax information store 214 suitably includes conditions and values for completing a corporate income tax return for donor enterprise 110. In other implementations, tax information store 214 may be replaced with a suitable store having conditions and/or values for determining whether conditions are met according to the special treatment potentially awardable to an enterprise (e.g., 110). Tax information store may conform to any conventional database structures. Platform independent format is preferred. In one implementation tax information store includes information in a markup language such as Extended Markup Language (XML). In another implementation a document object model is used for tax information store 214.

Conditions may be stored as executable or interpretable instructions (e.g., subroutines, libraries, modules, objects, scripts, applets) for execution by a processor (e.g., 112, 114, 116, and/or 140). For instance, continuing with the tax deduction for charitable donation example, tax information store 214 may include a value indicating what form of business organization corresponds to donor enterprise 110 and its tax situs (e.g., state). Coordinator 144 may, on receiving such information, download suitable modules (e.g., for processors 112, 114, and 116) that may be tailored for the law applicable to donor enterprise 160 (e.g., particular state law and/or type of entity). In an alternative implementation, particulars of donor enterprise's form and situs are retained behind firewall 120 and all necessary modules are received, selectively installed, selectively activated, and performed by suitable processors (e.g., 112, 114, and 116).

An alerting process assures that decision support is provided in a timely manner. For example, a transfer into or out of inventory may require a lead time. Lead time may include time for the decision to be considered and made, for coordination between entities selected for the transfer, for transportation, and for payment. Application for special treatment may require that the transfer be completed prior to a deadline date. Further, a disposition of an over-valued and/or under-utilized resource may desirably be a short time after the resource is determined to be over-valued and/or under-utilized.

For example, alerting process 206 has access to current date and time of day, has access to inventory store 204 for the description of resources. The description of each resource in inventory may include conventional descriptors, a present value for age of the resource, and a present value for the resource. Inventory store 204 may further include an association of each resource and alerting parameters used by alerting process 206 in response to subscriptions as discussed below.

Alerting process 206 determines whether any resource in inventory is over-valued and/or under-utilized and consequently provides to estimating process 234 notice of same consistent with a user specified lead time which may be different for different types of resources. Alerting process 206 may further be tailored to definitions of lead time that are consistent with tax information 214.

In one implementation, estimating process 234 subscribes to notices from alerting process 206 and alerting process 206 fulfills these subscriptions. Each subscription may define the type of resource, the applicable conditions that if met determine whether a resource of that type is over-valued or under-utilized, and lead time for providing suitable notice to estimating process 234. Alerting process 206 may request from time to time that estimating process 234 update the present value of a resource of inventory store 204 by storing a suitable value in store 204.

An estimating process produces estimates and projections, determines the effects of special treatment(s), and interacts with a user to support a decision to be made by the user. For example, estimating process 234 accesses tax information store 214 suitable reports from donation service provider 140 to determine a set of conditions to be monitored and periodically tested. Further, process 234 may recall from store 214 present values of parameters to test the conditions as well as instructions as discussed above to suitably perform these tests. Tests as to whether a type of resource is over-valued or under-utilized may be performed by alerting process 206 or by estimating process 234 or both. Coordinator process 144 may provide present values of parameters (e.g., appraised values of resources) to test the conditions as well as instructions as discussed above to suitably perform tests.

Estimating process 234 may provide a report to user 248 via GUI 232 having indicia of a consequence of special treatment. Such indicia may be conclusory, recommending a best alternative to the decision maker. In alternate implementations, such indicia may present intermediate conclusions with and without the effect of the special treatment. In yet another implementation, a comparison among and/or difference between projected results may be presented.

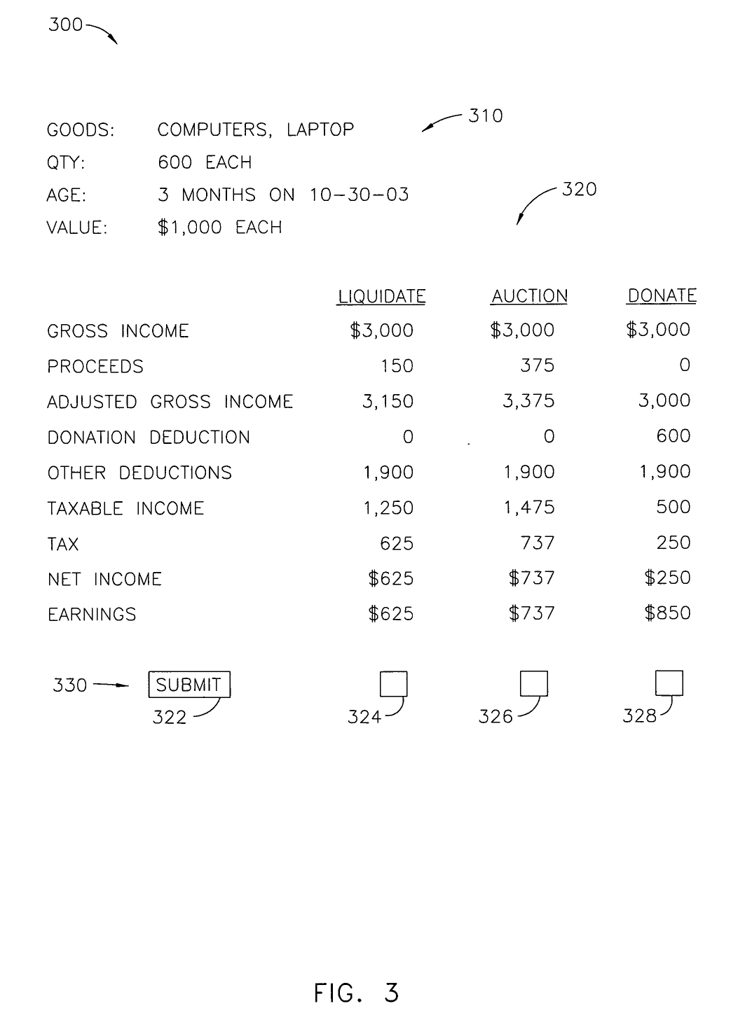

Continuing, for example, with the scenarios discussed above for special treatment under corporate income tax law for a charitable donation of surplus inventory, estimating process 234 may provide report 300 of FIG. 3 as a conventional hypertext page having suitable controls for indicating that a decision has been made by user 248. Report 300 may appear on a screen of a monitor of user platform 112. Report 300 includes a description 310 of surplus goods to be dispositioned (e.g., an aged resource that may also be over-valued due to weakening market demand), a set 320 of projections, and a set 330 of controls. The description includes a value (i.e., $1,000 each) provided by coordinator 144. Other descriptors were drawn from inventory store 204 by process 234. The projections abbreviate dollar values in thousands for convenience. The projections include a projected after tax earnings for each alternative disposition: sale by a liquidator, sale by auction, and donation to a requester enterprise (e.g., 160). After tax earnings are obtained from gross earnings plus proceeds, less other deductions (considered to be actual expenditures), and less tax.

User 248 may check one of conventional radio controls 324, 326, and 328 and activate a conventional submit control 322. On activation of submit control 322, a conventional message (e.g., an HTTP form) is submitted to donation service provider 140. Coordinator process 144 may in reply activate dispositioning process 236 in accordance with an association of donor enterprise 110, requester enterprise 160, resources requested, and the request for gift as discussed above. In an alternate implementation, activating the submit control activates dispositioning process 236 and process 236 cooperates as needed with coordinator process 144 and/or requester enterprise 160 or shipper/escrow agent (not shown) as discussed above.

A dispositioning process facilitates cooperation in any conventional manner between donor enterprise 110, requester enterprise 160, and the users and/or employees of each to effect the decided disposition. For example, dispositioning process 236 may receive contact information from donation service provider and report same to user 248. In the case of the other alternative decisions (324 or 326) dispositioning process 236 may perform any conventional actions such as initiating a sales order as discussed above.

A method, according to various aspects of the present invention, is performed by a computer system for decision support. The method includes the following operations in any order: (a) compiling a plurality of attributes for each respective donor of a plurality of donors; (b) compiling a plurality of attributes of donatable goods respectively for each of the donors; (c) compiling a plurality of attributes for each requester of a plurality of requesters; (d) compiling a plurality of attributes of requests for donatable goods respectively for each of the requesters; (e) associating a particular donor with a particular requester in accordance with an attribute of a donatable good of the particular donor, and an attribute of a request of the particular requester; (f) estimating a tax consequence to the particular donor from donating by the particular donor the donatable good; and (g) providing indicia of the tax consequence in support of a decision whether to donate.

A method, according to various aspects of the present invention, is performed by a computer system, for decision support. The method includes the following operations in any order: (a) estimating a first tax consequence from selling goods; (b) estimating a second tax consequence from donating the goods; and (c) providing indicia in accordance with the first tax consequence and the second tax consequence in support of a decision whether to donate the goods. In another implementation, the method further includes: associating the goods with a respective planned date for disposition of the goods; and providing the indicia in advance of the planned date.

A computer automated inventory management system, according to various aspects of the present invention, performs a method for dispositioning over-valued or under-utilized goods of the inventory. The method includes providing information to a tax planning system (234, 212, 214) for estimating a tax consequence of dispositioning the goods, the information being provided at a time in advance of the goods attaining a limit age or a limit utilization.

A method, according to various aspects of the present invention, is performed by a computer system for decision support. The method includes the following operations in any order: (a) receiving from an inventory management system information for estimating a tax consequence of dispositioning aged goods of the inventory, the information being received at a time in advance of the goods attaining a limit age; (b) estimating a first tax consequence from selling goods; (c) estimating a second tax consequence from donating the goods; and (d) providing indicia in accordance with the first tax consequence and the second tax consequence in support of a decision whether to donate the goods. In another implementation, the method further includes receiving information from an accounting system for estimating a tax liability in accordance with the second tax consequence.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A method, performed by a computer system, for decision support comprising:
compiling a plurality of attributes for each respective donor of a plurality of donors;
compiling a plurality of attributes of donatable goods respectively for each of the donors;
compiling a plurality of attributes for each requester of a plurality of requesters;
compiling a plurality of attributes of requests for donatable goods respectively for each of the requesters;
associating a particular donor with a particular requester in accordance with an attribute of a donatable good of the particular donor, and an attribute of a request of the particular requester;
estimating a tax consequence to the particular donor from donating by the particular donor the donatable good; and
providing indicia of the tax consequence in support of a decision whether to donate.

2. A method, performed by a computer system, for decision support comprising:
estimating a first tax consequence from selling goods;
estimating a second tax consequence from donating the goods; and
providing indicia in accordance with the first tax consequence and the second tax consequence in support of a decision whether to donate the goods.

3. The method of claim 2 further comprising:
associating the goods with a respective planned date for disposition of the goods; and
providing the indicia in advance of the planned date.

4. A computer automated inventory management system comprising a method for dispositioning aged goods of the inventory, the method comprising providing information to a tax planning system for estimating a tax consequence of dispositioning the goods, the information being provided at a time in advance of the goods attaining a limit age.

5. A method, performed by a computer system, for decision support comprising:
receiving from an inventory management system information for estimating a tax consequence of dispositioning aged goods of the inventory, the information being received at a time in advance of the goods attaining a limit age;
estimating a first tax consequence from selling goods;
estimating a second tax consequence from donating the goods; and
providing indicia in accordance with the first tax consequence and the second tax consequence in support of a decision whether to donate the goods.

6. The method of claim 5 further comprising:
receiving information from an accounting system for estimating a tax liability in accordance with the second tax consequence.
